(19) United States
(12) Patent Application Publication
(10) Pub. No.: US 2013/0036050 A1
(43) Pub. Date: Feb. 7, 2013

(54) SYSTEM AND METHOD FOR USING A NEAR FIELD COMMUNICATION DEVICE TO CONDUCT A TRANSACTION WITH AN ALIAS

(71) Applicants: JOSEPH A. GIORDANO, Waxhaw, NC (US); YVETTE BOHANAN, San Jose, CA (US)

(72) Inventors: JOSEPH A. GIORDANO, Waxhaw, NC (US); YVETTE BOHANAN, San Jose, CA (US)

(73) Assignee: BANK OF AMERICA CORPORATION, Charlotte, NC (US)

(21) Appl. No.: 13/342,084

(22) Filed: Jan. 1, 2012

Related U.S. Application Data
(60) Provisional application No. 61/514,256, filed on Aug. 2, 2011.

(51) Int. Cl. G06Q 20/22; G06Q 20/40

(52) U.S. Cl. 705/44; 705/39

(57) ABSTRACT

A system and method for using a static or dynamically-generated alias to conduct financial transactions via a Near Field Communication Device at a merchant is provided. The system and method allows a user to provide an alias identifying the user in order to conduct transactions via a near field communication device without needing to transfer the user's account number. The method associates the alias with an account of the user. The alias may be a static alias or a dynamic alias. A dynamic alias is generated for a transaction based in part on a characteristic of the transaction. The method determines the account number associated with the alias and completes the transaction using the alias. The method may also evaluate the transaction to determine whether pre-determined rules are complied with and provide confirmation to the user and/or merchant that the transaction has completed.

### CLAIM OF PRIORITY UNDER 35 U.S.C. §119

The present Application for Patent claims priority to Provisional Application No. 61/514,256, entitled “SYSTEM AND METHOD FOR USING A NEAR FIELD COMMUNICATION DEVICE TO CONDUCT A TRANSACTION WITH AN ALIAS” filed Aug. 2, 2011, and assigned to the assignee hereof and hereby expressly incorporated by reference herein.

### BACKGROUND

With the wide adoption of credits cards, debit cards, electronic payment devices, online shopping systems, and online banking systems, very few people today carry a lot of cash or write many checks. However, people still need to transfer money with businesses for all sorts of reasons. For example, a person may want to purchase something in a store or a person may want to receive a refund when returning a purchase. Giving or receiving money from a business, however, can be difficult when you don't have cash on hand. The process may need to involve going to an automated teller machine (ATM), which can be time consuming and inconvenient. The process may also include paying with a personal check, credit card, or debit card but these can be lost, increasing the risk of fraud because the customer's account number is present on these payment devices.

Money can be transferred to a business using electronic banking systems, but these systems traditionally require that the sender provide account information to the business in order to instruct the bank to transfer money to the proper account. Most people do not know their own account numbers, nor do most people want to widely publicize their account numbers for security reasons.

Some third party service providers try to facilitate payments from one entity to another, but many people do not like these systems because they require opening yet another account with another online entity, remembering yet another username and password, and disclosing confidential financial institution account information to these other companies. In addition to the inconvenience and the security concerns, these systems generally take time to set up and are not user-friendly.

For all these reasons and others, there is a need for improved user-friendly systems and methods for transferring money between individuals and businesses, especially if such systems can transfer money directly to and/or from financial institution accounts, such as demand deposit accounts (e.g., checking accounts), savings accounts, and/or credit accounts.

### BRIEF SUMMARY

Embodiments of the present invention address these and/or other needs by providing an innovative person-to-merchant (P2M) payment system along with a user-friendly interface and process for sending and receiving P2M payments via a near field communication device. Advantageously, embodiments of the invention do not necessarily require users to share confidential account information with others in order to send and receive payments. In fact, embodiments of the invention do not require that the payment sender know any information about the financial accounts of the intended payment recipient.

More specifically, embodiments of the invention allow an entity to transfer funds to a business using a static or dynamically-generated alias for the user. The assignee of the present application describes some embodiments of such an invention in U.S. Provisional Patent Application No. 61/410,085, filed Nov. 4, 2010, which is incorporated herein by reference. The assignee of the present application describes some further embodiments of such an invention in U.S. Provisional Patent Application No. 61/410,087, filed Nov. 4, 2010, which is incorporated herein by reference. The assignee of the present application describes some still further embodiments of such an invention in U.S. Provisional Patent Application No. 60/991,172, filed on Nov. 29, 2007, and co-pending U.S. patent application Ser. No. 12/038,177, filed on Feb. 27, 2008, as well as in U.S. patent application Ser. Nos. 12/881,071, 12/881,073, 12/881,074, and 12/881,080 continuing therefrom; all of which are incorporated herein by reference. Embodiments of the present invention include and build off of those earlier embodiments to provide an improved P2M payment system and a more user-friendly, secure, and convenient user interface and method.

In an exemplary embodiment of the invention, a computer-implemented method for conducting a financial transaction via a near field is provided. In an embodiment, the computer-implemented method includes receiving an alias for a user from a merchant, wherein the merchant received the alias via the near field communication device. The computer-implemented method then determines an account associated with the alias and conducts the financial transaction using the account. In some embodiments, the alias is a static alias comprising an issuer identification number, a bank identification number, a user identification number, and a payment identification number. The issuer identification number and bank identification number assist the computer-implemented method in routing the financial transaction. The user identification number is associated with a user in a database available to the financial institution. When the user is identified, the payment identification number allows the financial institution to identify a payment method, such as a checking account or credit card, that will be used for the transaction.

In further embodiments, the alias is a dynamic alias that is dynamically generated for the transaction. In some embodiments, the dynamic alias is generated for each transaction. For example, the dynamic alias may be generated by modifying at least one alias of the transaction using an algorithm. In further embodiments, the algorithm modifies the alias based on a characteristic of the transaction. The algorithm may modify the alias based on the time of the transaction, the location of the transaction, or the amount of the transaction. In some embodiments, the computer-implemented method receives the characteristic of the transaction from the merchant but in other embodiments the computer-implemented method receives the characteristic of the transaction from the user. For example, the user's mobile device may transfer the time of the transaction to the financial institution at the same time that the mobile device is transferring the alias to the merchant via the near field communication device

In another embodiment of the invention, a computer program product for conducting a financial transaction via a near field communication device is provided. The computer program product comprises a computer-readable medium having computer-executable instructions for causing a computer to receive an alias for a user from a merchant, wherein the merchant receives the alias via a near field communication device. The computer-executable instructions also cause a computer to determine an account associated with the alias and conduct the financial transaction using the account. In some embodiments, the computer program product further comprises computer-executable instructions for causing a computer to modifying the alias based on a characteristic of the transaction.

The alias may be modified using an algorithm to determine the user identification number and/or the payment identification number from an alias that has been dynamically generated for the transaction. The alias may be modified based on the location of the transaction, the time of the transaction, or the amount of the transaction. In some embodiments, the computer program product receives the characteristic of the transaction from the merchant but in other embodiments the computer program product receives the characteristic of the transaction from the user. In further embodiments, the computer program product includes computer-executable instructions for causing a computer to provide coupons or discounts associated with the transaction. In other embodiments, the computer program product includes computer-executable instructions for causing a computer to inform the merchant that the transaction completed.

In a still further embodiment of the invention, a system for conducting a financial transaction via a near field communication device is provided. The system includes a computer apparatus including a processor and a memory, as well as a payment system module stored in the memory, executable by the processor, and configured to receive an alias for a user from a merchant, wherein the merchant receives the alias via a near field communication device. The payment system module is further configured to determine an account associated with the alias and conduct the financial transaction using the account. In some embodiments, the payment system module determines the account associated with the alias by determining routing of the transaction from an issuer identification number and bank identification number, determining a user from a user identification number, and determining a payment method for the user from a payment identification number.

In further embodiments, the system includes a near field communication receiver at the merchant for receiving the alias from the user and a communication device at the merchant for transmitting the alias from the merchant to the financial institution. In some embodiments, the system includes a database, which may be integral with the financial institution or separate from the financial institution, wherein the database associates the user identification number with a user and associates the payment identification number with a payment method for the user. In an embodiment, the system uses an algorithm to determine the user identification number and/or the payment identification number from the alias.

As described in greater detail below, the user interface can be incorporated into a mobile banking application of a bank or other financial institution. The user can use the mobile banking application or a website to register a static alias or create a dynamically-generated alias associated with one of the user's financial institution accounts. This association is then stored in a data repository that can be accessed by the mobile device, business, bank, and/or other financial institutions. Some embodiments of the invention provide a system for verifying that the alias is owned, held, or otherwise associated with the user. In an embodiment, the user is able to conduct a transaction at a business by providing the user's alias to the business via a near field communication device.

Embodiments of the invention also provide a user interface that makes it easy for users to monitor their current, future, pending, and past person-to-merchant (P2M) and/or merchant-to-person (M2P) funds transfers as well as their saved transfer recipient list, previous transactions, incoming transfers, and/or other related information.

It should be appreciated that at least some embodiments of the invention provide a more convenient, user friendly, and secure P2M payment system because it is provided by the user's bank through the bank's banking application with which the user is already familiar. In at least some embodiments, the user may not need to share personal or confidential information, such as account information, with people or businesses outside of the user's bank. The user can feel more secure having P2M services handled by their bank and having the convenience of being able to directly send money from and/or receive money into the user's financial institution accounts.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 is a flowchart for a method for making P2M payments in accordance with an embodiment of the invention;

FIG. 2 is a block diagram illustrating the process by which a user may make P2M payments in accordance with various embodiments of the invention;

FIG. 3 provides a block diagram illustrating a P2M payment system and environment in accordance with embodiments of the invention;

FIG. 4 provides a block diagram illustrating the user's mobile device of FIG. 3 in accordance with an embodiment of the invention;

FIG. 5 provides a block diagram illustrating the alias determination server of FIG. 3 in accordance with an embodiment of the invention;

FIG. 6 provides a block diagram illustrating the financial institution's banking system of FIG. 3 in accordance with an embodiment of the invention; and

FIGS. 7A-7B provide flow charts illustrating a process for sending P2M payments to a business with an alias using a near field communication device in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “bank,” “financial institution,” or “financial entity” include any organization that processes financial transactions including, but not limited to, banks, credit unions, savings and loan associations, investment companies, stock brokerages, asset management firms, insurance companies and the like. In specific embodiments of the invention, use of the term “bank” is limited to a financial entity in which account-bearing users conduct financial transactions, such as account deposits, withdrawals, transfers and the like.

Embodiments of the present invention provide a system and method for mobile banking person-to-merchant (P2M) payments conducted via a Near Field Communication (NFC) device. Embodiments of the invention allow users of a financial entity to make payments directly from their accounts, whether their accounts be checking, savings, line of credit, credit card, and/or other accounts, to a business, including small business users and national-scale business users, without having to share any confidential account information and without having to know account information for the intended recipient. Embodiments of the invention also allow users to receive payments from businesses directly into their financial institution accounts without requiring the user to share account information with the business. It should be noted that some embodiments of the invention allow a user to make payments to and/or receive payments from a merchant in the same way that a user can make payments to and/or receive payments from another person. As such, as used herein, the phrase person-to-merchant (P2M) is intended to include person-to-person (P2P), merchant-to-merchant (M2M), and merchant-to-person (M2P) unless specifically stated otherwise.

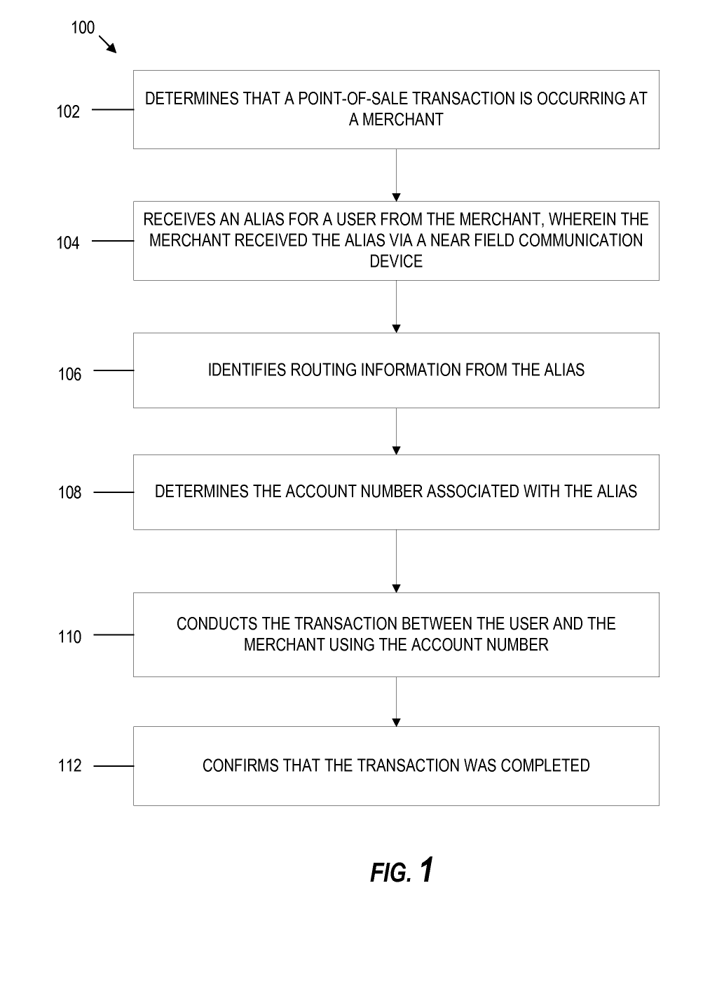

FIG. 1 is a flowchart providing an overview of a system and a computer-implemented method 100 for using a near field communication device to conduct a transaction with an alias, in accordance with one or more embodiments of the invention. A user with an eligible account, e.g., checking (demand deposit account or “DDA”), savings, money market, line of credit, credit card, etc., is able to register and make use of this service. During the registration process, the user is able to designate an account that will be used with an alias that maps back to the user's selected account. In an embodiment, the alias is a static or dynamic identifier other than the user's financial institution account number. In some embodiments, a different dynamic alias is generated for each transaction. In further embodiments, the dynamic alias is associated with the user or the user's account by an algorithm, such as an algorithm that modifies a user identification numbering using a characteristic transaction.

In block 102, the computer-implemented method 100 determines that a transaction is occurring. In an embodiment, the transaction is occurring at a point-of-transaction device, such as a register in a business, an ATM, or a NFC-enabled mobile device. In some embodiments, the computer-implemented method is implemented by a banking system of a financial institution. The banking system receives the transaction authorization request comprising the alias from a point-of-sale device along the same or similar channels as the banking system would receive a request using a standard account number. In some embodiments, the transaction authorization request goes to a secondary financial institution first, which recognizes the transaction as associated with a first or primary financial institution and transfer the transaction data to the first financial institution. In a still further embodiment, the computer-implemented method 100 is alerted to a transaction at a point-of-sale device via the user's mobile device. For example, the user's mobile device may inform the financial institution's banking system that a transaction is occurring by wirelessly connecting to the banking system over a wireless network.

In block 104, the computer-implemented method 100 receives an alias from the merchant, wherein the merchant received the alias via a near field communication device. In some embodiments, the alias comprises various elements that allow the computer-implemented method to route the transaction to the correct financial institution and the correct account. For example, the elements of the alias may include an issuer identification number, a bank identification number, a user identification number, a payment identification number, and a checksum, as will be described in greater detail later. In some embodiments, the alias also includes an indication that the number is an alias instead of an account number. The alias can be used in a similar manner to an account number but with reduced risk. The computer-implemented method receives the alias over a network. In an embodiment, the alias is received with the transaction authorization request from a point-of-sale device. For example, the point-of-sale device may transfer a transaction authorization request including both the transaction amount and the alias to the banking system. In some embodiments, the alias is encrypted by the merchant prior to communicating the alias to the financial institution's banking system operating the computer-implemented method 100.

In an embodiment, the computer-implemented method 100 establishes default aliases for users. The default alias may be a static alias stored in the user's mobile device and used to conduct transactions via near field communication devices. In some embodiments, the static alias is a unique identifier for an individual. The static alias is not the account number but can be matched up to the account number by the financial institution. In one embodiment, static aliases are established as default aliases for users when registering for the P2M service. In another embodiment, the computer-implemented method 100 prompts the user to approve a random or default static alias. When the user selects the static alias, the computer-implemented method may confirm that the static alias meets pre-defined criteria. For example, the pre-defined criteria may include that a user cannot register another user's static alias, that the static alias does not map to an existing account number, or that the static alias is not easily guessed or otherwise inappropriate. In some embodiments, the computer-implemented method 100 receives the static alias from the point-of-sale device and associates the static alias with the user.

In further embodiments, the computer-implemented method 100 receives a dynamic alias that has been dynamically-generated for the user. For example, when the user activates a P2M application on a mobile device, a dynamic alias may be generated by the P2M application for a one-time transaction. The P2M application may generate the dynamic alias when the user's mobile device communicates with the point-of-sale device via the near field communication device. In one embodiment, the dynamic alias is randomly generated. The P2M application generates a random or pseudo-random alias comprising an issue identification number, a bank identification number, a user identification number, and a payment identification number. In some embodiments, the user identification number is modified based on an algorithm to change the user identification number for each transaction. In further embodiments, other elements of the alias are modified, such as the bank identification number, is modified by an algorithm so that the alias changes with each transaction. In this manner, the alias is a number that can be used in a similar manner to a standard account number but with increased security.

In one embodiment, the computer-implemented method modifies at least a portion of the alias further based on a characteristic of the transaction that changes with each transaction. For example, the dynamic alias may be generated based on the time of the transaction, the amount of the transaction, or the location of the transaction. These methods of generating dynamic aliases will be discussed further later.

In some embodiments, the static and/or dynamic aliases are linked to one or more of the user's financial institution accounts of the user. The financial institution accounts may include checking accounts, savings accounts, line of credit accounts, P2M-specific accounts, reward point accounts, gift card accounts, investment accounts, or other types of financial accounts. In some embodiments, the aliases and financial institution accounts are archived in a data repository maintained by the financial institution or some other entity that provides an alias registry service to the financial institution.

In some embodiments of the invention, the user may also have an option of opening a new P2M account with the financial institution that the user may use exclusively for making and/or receiving P2M payments. This financial entity P2M account may be like any other account hosted at the financial entity and so money may be moved instantly into this account through the regular banking transfer process for moving money between a user's accounts. This account may be a type of checking account except that it may come with certain limitations, e.g., no checks, maximum balance limits, number of daily transactions or the like, and may be opened by users by providing much less information as compared to a regular checking account. The financial entity may, at a minimum, require users to provide certain information, such as name, address, date of birth, and social security number, in order to comply with Anti-Money Laundering (AML) regulations. Users of the financial entity may also have an option to set up P2M accounts (i.e., sub-accounts) for minors, other dependents, or related entities. Users are able to access these accounts just like any of their other accounts. In addition, users are able to set up a banking access ID for the minor that the minor may use to access only the specific minor P2M account set up for them. These P2M-specific accounts and sub-accounts are described in more detail in U.S. patent application Ser. No. 12/038,177 filed on Feb. 27, 2008 and entitled “Sub-Account Mechanism,” which application was assigned to, or subject to an obligation to assign to, the same assignee of the present application at the time of filing of the present application and at the time of conception of the inventions described herein.

In block 106, in some embodiments the computer-implemented method 100 determines the routing information for the transaction from the alias. The routing information is used to determine the financial institution offering or hosting the financial account. In some embodiments, the issuer identification number and the bank identification number determine the routing information. The issuer identification number is the payment method, such as Visa™ or Mastercard™, that is being used for the transaction. Standard issuer identification numbers are known to represent different issuers, e.g., 34 and 37 represents American Express™, 41 through 49 represents Visa™, 51 through 55 represents Mastercard™, 60 and 65 represents Discover™, 36 and 38 represent Diner's Club™, etc. The bank identification number is the bank that issues the Visa™ or Mastercard™ and can be four digits long. For example, a transaction may be routed through a Visa™ card issued by Bank A. In an exemplary embodiment, the issuer identification number and bank identification number are six digits long and assist the computer-implemented method in routing the transaction to the proper financial institution.

In block 108, the computer-implemented method 100 determines the account number associated with the alias. If the alias is a static alias, the computer-implemented method 100 matches the user identification number in the static alias with a user by means of a database of static aliases available to the financial institution. In some embodiments, the user is able to change the static alias using the P2M application, a web-based module, or by communicating with the financial institution (e.g., over the phone, at an ATM, at a bank branch, etc.). In some embodiments, the static alias is only available for a limited time or limited number of transactions before it expires and must be changed.

In some embodiments, the computer-implemented method determines that the alias is a dynamic alias and, in coordination with the alias determination server, determines the user from the dynamic alias. The computer-implemented method determines the user identification number from the dynamic alias and identifies the user associated with the user identification number. In some embodiments, the method uses the algorithm to determine the user identification number. For example, the computer-implemented method may determine the time of the transaction, the location of the transaction, or the amount of the transaction and using that information along with the dynamic alias, determine the user identification number associated with the dynamic alias. This user identification number may in turn be matched with a user in a database available to the financial institution.

After identifying the user based on the user identification number, the computer-implemented method determines the payment method of the user based on the payment identification number. The payment identification number indicates which of the user's accounts the user desires to use for the transaction. In an embodiment, the payment identification number is a three digit number, such as from 000 to 999. Each three digit number maps to a different payment method of the user. For example, 001 may map to the user's checking account while 002 may map to the user's Visa™ account issued from a secondary bank. The computer-implemented method routes to the proper financial account by identifying the user and the payment method for each transaction.

In block 110, the computer-implemented method 100 completes the transaction (i.e., transfer is initiated), as described in greater detail below. While the method has been discussed as conducting transactions at point-of-sale devices, it should be understood that a transaction can be conducted via near field communication device in a variety of situations. For example, the user may use the method to conduct a transaction at an ATM, at a gas station pump, in coordination with a device used by a waiter in a restaurant, at a car rental location, etc.

In block 112, the computer-implemented method 100 confirms that the transaction was conducted according to the rules established by the user and/or financial institution. In an embodiment, a bank network confirmation, text message, email, online banking notice, mobile banking notice, or other type of message may be sent to the business and/or user. If there is other contact information found in the business's profile, the message notifying the business of the payment may be sent by the business's preferred contact method. In some embodiments, the business may be allowed to reject or re-route the payment. In some embodiments of the invention, the user is permitted to include a note to the business along with the payment, such as a note explaining the purpose of the payment to the business. In an embodiment, the user's actual account number is not transmitted to the business or the user.

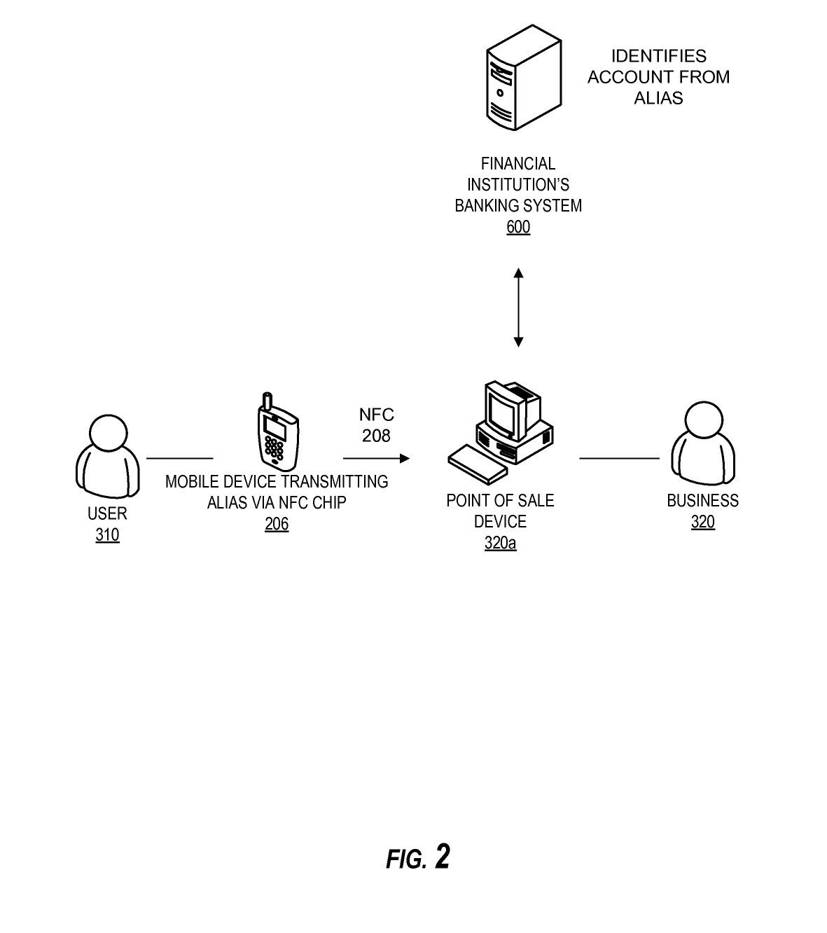

FIG. 2 is a block diagram illustrating a non-limiting example by which a user may make P2M payments in accordance with various embodiments of the invention. As illustrated, in an embodiment of the invention, a user 310 who is signed up for the P2M payment service initiates a P2M payment by activating a P2M application on a mobile device 206, accepting a default payment method, connecting the mobile device 206 with a point-of-sale device 320a via a near field communication device 208 (NFC), and transferring a static or dynamic alias to the point-of-sale device 320a. The point-of-sale device 320a, after receiving the alias from the user, communicates the alias and the transaction amount to the banking system 600 associated with a financial institution, which identifies an account number from the alias, confirms and completes the transaction, and in some embodiments sends the business 320 and the user 310 confirmation of the transaction.

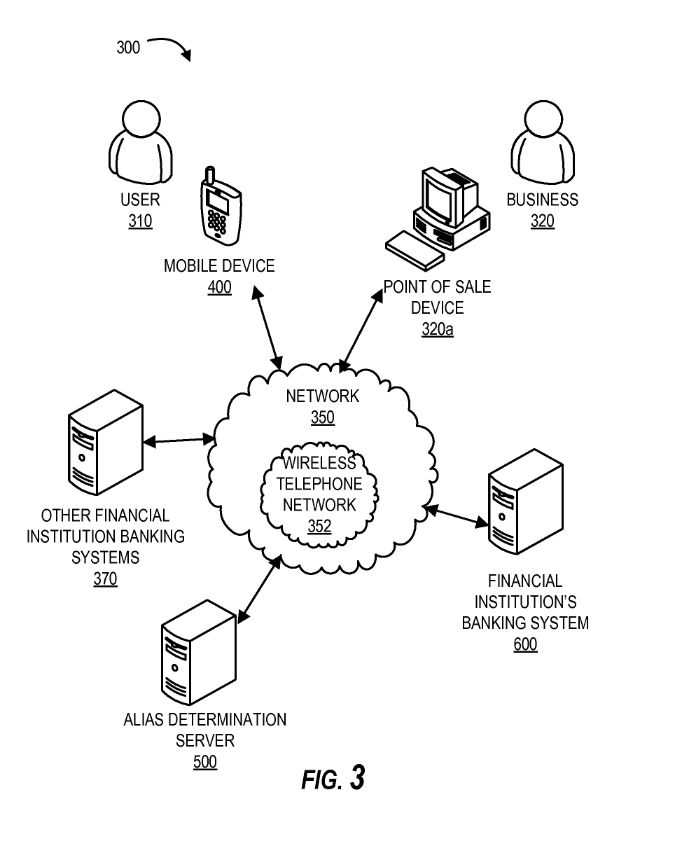

As described above, FIGS. 1 and 2 provide an overview of the alias-type P2M payment system and process of embodiments of the invention. FIGS. 3-7, described below, provide a more detailed description of some systems and methods of implementing embodiments of the invention in a mobile banking environment. Specifically, embodiments of the invention described below disclose a user-friendly mobile banking interface and associated method that may be used by a financial institution to: (1) allow users to send P2M payments via NFC using static or dynamically-generated aliases; and (2) allow users to easily manage their P2M and M2P payments.

FIG. 3 provides a block diagram illustrating a P2M payment system and environment 300, in accordance with an embodiment of the invention. As illustrated in FIG. 3, the environment 300 includes the user 310 and a business 320 where the user wants to send funds to the business. In another embodiment, the merchant wants to send funds to the user.

In some embodiments, the environment 300 includes a mobile device 400 for the user 310. As used herein, a “mobile device” 400 is any mobile device, such as a cellular telecommunications device (i.e., a cell phone or mobile phone), personal digital assistant (PDA), a mobile Internet accessing device, or other mobile device. In some embodiments, the mobile device 400 employs a processor and memory and can perform computing functions.

The mobile device 400 is configured to communicate over a network 350 with a financial institution's banking system 600 and, in some cases, one or more other financial institution banking systems 370. The network 350 may include a local area network (LAN), a wide area network (WAN), and/or a global area network (GAN). The network 350 may provide for wireline, wireless, or a combination of wireline and wireless communication between devices in the network. In one embodiment, the network 350 includes the Internet. In one embodiment, the network 350 includes a wireless telephone network 352. In a further embodiment, the network 350 includes a near field communication (NFC) network.

In general, the mobile device 400 is configured to connect with the network 350 to log the user 310 into the banking system 600. In some embodiments, the banking system 600 involves authentication of the user in order to access the user's account on the banking system 600. For example, the banking system 600 may be a system where the user 310 logs into his/her account such that the user 310 or other entity can access data that is associated with the user 310. For example, in one embodiment of the invention, the banking system 600 is a mobile banking system maintained by a financial institution. In such an embodiment, the user 310 can use the mobile device 400 to log into the mobile banking system to access the user's financial accounts. Logging into the banking system 600 generally requires that the user 310 authenticate his/her identity using a user name, a passcode, a cookie, a biometric identifier, a private key, a token, and/or another authentication mechanism that is provided by the user 310 to the banking system 600.

The financial institution's banking system 600 is in network communication with other devices, such as other financial institutions' banking systems 370, an alias determination server 500, and a point of sale device 320a that is configured to communicate with the network 350 to log the business 320 into the banking system 600. In an embodiment, the point-of-sale device 320a is a Near-Field Communication (NFC) enabled device or another type of device capable of communicating with the mobile device 400 of the user 310. In an embodiment, the point-of-sale device includes a NFC chip capable of syncing with and/or communicating with another NFC chip in the vicinity of the point-of-sale device. In a further embodiment, the point-of-sale device 320a may be network-enabled and able to communicate with the user's device 400 over a wireless network or via Bluetooth™. In another embodiment, the point-of-sale device 320a communicates with the banking system 600, which in turn communicates the mobile device 400, and thus communication is enabled between all devices on the network 350 through relays.

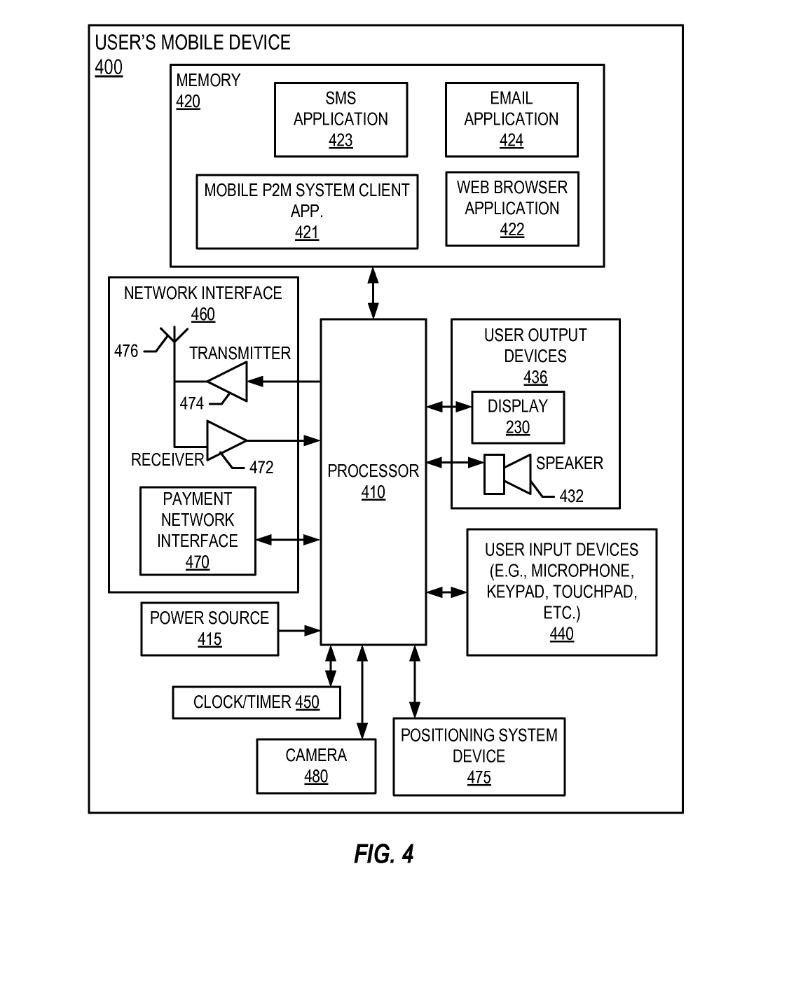

FIG. 4 provides a block diagram illustrating the mobile device 400 of FIG. 3 in more detail, in accordance with embodiments of the invention. In one embodiment of the invention, the mobile device 400 is a mobile telephone. However, it should be understood, however, that a mobile telephone is merely illustrative of one type of mobile device 400 that may benefit from, employ, or otherwise be involved with embodiments of the present invention and, therefore, should not be taken to limit the scope of embodiments of the present invention. Other types of mobile devices 400 may include portable digital assistants (PDAs), pagers, mobile televisions, gaming devices, laptop computers, cameras, video recorders, audio/video player, radio, GPS devices, or any combination of the aforementioned.

The mobile device 400 generally includes a processor 410 communicably coupled to such devices as a memory 420, user output devices 436, user input devices 440, a network interface 460, a power source 415, a clock or other timer 450, a camera 480, and a positioning system device 475. In an embodiment, the network interface 460 includes a Near Field Communication device capable of communicating with other NFC enabled devices. The NFC device is capable of short range wireless transfer of data. In some embodiments, the range of the NFC signal is intentionally reduced such that the NFC signal is unlikely to be accessible to any NFC devices other than the NFC device that the user touches with the mobile device. In some embodiments, the NFC device generates a radio frequency (RF) field that is capable of powering another NFC device. In one embodiment, the NFC device on the mobile device is powered, such as by the power source for the mobile device or by a dedicated power source. In another embodiment, the NFC device on the mobile device is not powered and receives power from the NFC device associated with the point-of-sale device. In a still further embodiment, both the NFC device on the mobile device and the NFC device on the point-of-sale device are actively powered. In an embodiment, the NFC device on the mobile device does not need to be paired with the NFC device at the point-of-sale prior to transferring data. In some embodiments, the NFC device encrypts the data prior to transferring the data.

The processor 410 and other processors described herein generally include circuitry for implementing communication and/or logic functions of the mobile device 400. For example, the processor 410 may include a digital signal processor device, a microprocessor device, and various analog to digital converters, digital to analog converters, and/or other support circuits. Control and signal processing functions of the mobile device 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 350. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless telephone network 352. In this regard, the mobile device 400 may be configured to operate with one or more air interface standards, communication protocols, modulation types, and access types. By way of illustration, the mobile device 400 may be configured to operate in accordance with any of a number of first, second, third, and/or fourth-generation communication protocols and/or the like. For example, the mobile device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 400 may also be configured to operate in accordance with non-cellular communication mechanisms, such as via a wireless local area network (WLAN), Bluetooth™ network, or other communication/data networks.

The network interface 460 may also include a payment network interface 470. The payment network interface 470 may include software, such as encryption software, and hardware, such as a modem, for communicating information to and/or from one or more devices on the network 350. For example, the mobile device 400 may be configured so that it can be used as a credit or debit card by, for example, wirelessly communicating account numbers or other authentication information to a terminal of the network 350.

As described above, the mobile device 400 has a user interface that is, like other user interfaces described herein, made up of user output devices 436 and/or user input devices 440. The user output devices 436 include a display 230 (e.g., a liquid crystal display or the like) and a speaker 432 or other audio device, which are operatively coupled to the processor 410. The user input devices 440, which allow the mobile device 400 to receive data from a user such as the user 310, may include any of a number of devices allowing the mobile device 400 to receive data from a user, such as a keypad, keyboard, touch-screen, touchpad, microphone, mouse, joystick, other pointer device, button, soft key, and/or other input device(s). The user interface may also include a camera 480, such as a digital camera.

The mobile device 400 may also include the positioning system device 475 that is configured to be used by a positioning system to determine a location of the mobile device 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile device 400. In other embodiments, the positioning system device 475 includes a proximity sensor or transmitter, such as an RFID tag, that can sense or be sensed by devices known to be located proximate a merchant or other location to determine that the consumer mobile device 400 is located proximate these known devices.

The mobile device 400 further includes a power source 415, such as a battery, for powering various circuits and other devices that are used to operate the mobile device 400. Embodiments of the mobile device 400 may also include a clock or other timer 450 configured to determine and, in some cases, communicate actual or relative time to the processor 410 or one or more other devices.

The mobile device 400 also includes the memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the mobile device 400 described herein. For example, the memory 420 may include such applications as a conventional web browser application 422, an SMS application 423, an email application 424, and/or a mobile P2M system client application 421. These applications also typically provide a graphical user interface (GUI) on the display 230 that allows the user 310 to communicate with the consumer mobile device 400, the banking system 600, and/or other devices or systems. In one embodiment of the invention, when the user 310 decides to enroll in the mobile banking program, the user 310 downloads or otherwise obtains the mobile banking system client application from the banking system 600 or from a distinct application server. In other embodiments of the invention, the user 310 interacts with the banking system 600 via the web browser application 422 in addition to, or instead of, the mobile P2M system client application 421.

The memory 420 can also store any of a number of pieces of information, and data, used by the mobile device 400 and the applications and devices that make up the mobile device 400 or are in communication with the mobile device 400 to implement the functions of the mobile device 400 and/or the other systems described herein. For example, the memory 420 may include such data as user authentication information, etc.

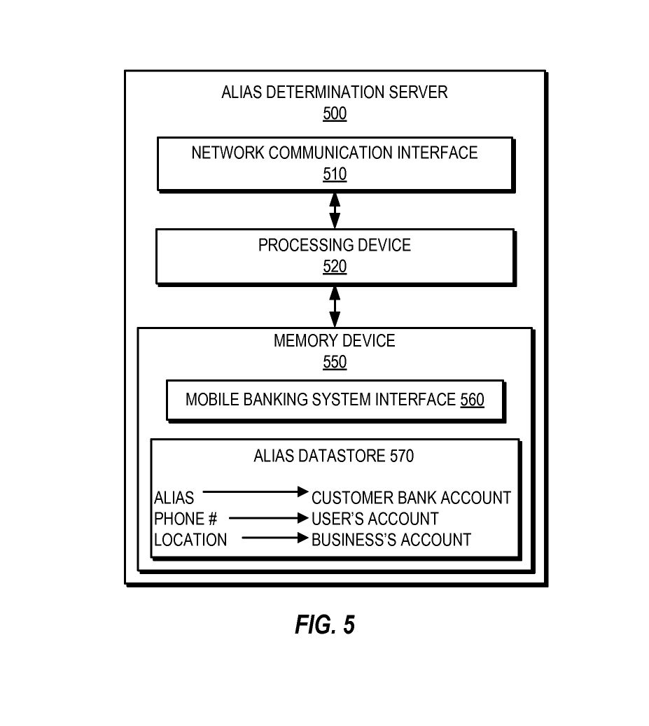

FIG. 5 provides a block diagram illustrating an alias determination server 500, in accordance with an embodiment of the invention. In one embodiment of the invention, the alias determination server 500 is operated by a second entity that is a different or separate entity from the first entity (e.g., the financial institution) that, in one embodiment of the invention, implements the banking system 600. In one embodiment, the alias determination server 500 could be part of the banking system 600. In another embodiment, the alias determination server 500 is a distinct entity from the banking system 600. As illustrated in FIG. 5, the alias determination server 500 generally includes, but is not limited to, a network communication interface 510, a processing device 520, and a memory device 550. The processing device 520 is operatively coupled to the network communication interface 510 and the memory device 550. In one embodiment of the alias determination server 500, the memory device 550 stores, but is not limited to, a mobile banking system interface 560 and an alias data store 570. The alias data store 570 stores data including, but not limited to, an alias for the user's financial institution account, rules associated with transactions conducted through the P2M system, locations of users and/or businesses, and contact information for the users and/or businesses registered with the P2M system. In one embodiment of the invention, both the mobile banking system interface 560 and the alias data store 570 may associate with applications having computer-executable program code that instructs the processing device 520 to operate the network communication interface 510 to perform certain communication functions involving the alias data store 570 described herein. In one embodiment, the computer-executable program code of an application associated with the alias data store 570 may also instruct the processing device 520 to perform certain logic, data processing, and data storing functions of the application associated with the alias data store 570 described herein.

The network communication interface 510 is a communication interface having one or more communication devices configured to communicate with one or more other devices on the network 350. The processing device 520 is configured to use the network communication interface 510 to receive information from and/or provide information and commands to a mobile device 400, other financial institution banking systems 370, the alias determination server 500, the banking system 600, and/or other devices via the network 350. In some embodiments, the processing device 520 also uses the network communication interface 510 to access other devices on the network 350, such as one or more web servers of one or more third-party data providers. In some embodiments, one or more of the devices described herein may be operated by a second entity so that the third-party controls the various functions involving the alias determination server 500. For example, in one embodiment of the invention, although the banking system 600 is operated by a first entity (e.g., a financial institution), a second entity operates the alias determination server 500 that determines the alias for the user's financial institution accounts and other information about users.

As described above, the processing device 520 is configured to use the network communication interface 510 to gather data from the various data sources. The processing device 520 stores the data that it receives in the memory device 550. In this regard, in one embodiment of the invention, the memory device 550 includes datastores that include, for example: (1) aliases, such as static aliases, for user financial institution account numbers and routing information, (2) algorithms for determining an account number from a dynamic alias (3) information about sending and receiving users' mobile device numbers, email addresses, customer support phone numbers, or other contact information, which may have been received from the banking system 600; (4) a list of user IDs or authentication data received from the banking system 600; and/or (5) user credentials (e.g., a user ID) received from the user's mobile device 400 or received from the banking system 600 in response to the user accessing the banking system 600.

In some embodiments of the invention, the alias determination server 500 is configured to be controlled and managed by one or more third-party data providers (not shown in FIG. 3) over the network 350. In other embodiments, the alias determination server 500 is configured to be controlled and managed over the network 350 by the same entity that maintains the financial institution's banking system. In other embodiments, the alias determination server 500 is configured to be controlled and managed over the network 350 by the financial institution implementing the mobile payment system of the present invention. In still other embodiments, the alias determination server 500 is a part of the banking system 600.

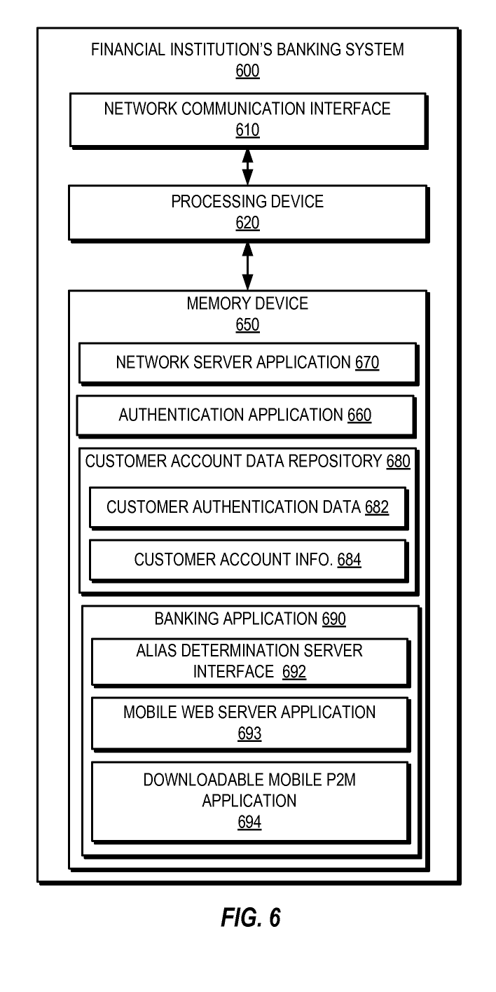

FIG. 6 provides a block diagram illustrating the banking system 600 in greater detail, in accordance with embodiments of the invention. As illustrated in FIG. 6, in one embodiment of the invention, the banking system 600 includes a processing device 620 operatively coupled to a network communication interface 610 and a memory device 650. In certain embodiments, the banking system 600 is operated by a first entity, such as a financial institution, while in other embodiments the banking system 600 is operated by an entity other than a financial institution.

It should be understood that the memory device 650 may include one or more databases or other data structures/repositories. The memory device 650 also includes computer-executable program code that instructs the processing device 620 to operate the network communication interface 610 to perform certain communication functions of the banking system 600 described herein. For example, in one embodiment of the banking system 600, the memory device 650 includes, but is not limited to, a network server application 670, an authentication application 660, a user account data repository 680, which includes user account data repository 680 and user account information 684, a banking application 690, which includes an alias determination server interface 692, and other computer-executable instructions or other data. In some embodiments the banking application 690 comprises a mobile web server application 693 that allows the user to change the static alias. The computer-executable program code of the network server application 670, the authentication application 660, or the banking application 690 may instruct the processing device 620 to perform certain logic, data-processing, and data-storing functions of the banking system 600 described herein, as well as communication functions of the banking system 600.

In one embodiment, the user account data repository 680 includes user authentication data 682 and user account information 684. The network server application 670, the authentication application 660, and the banking application 690 are configured to implement user account information 684 in collaboration with the user authentication data 682 and the alias determination server interface 692 when authenticating the user 310 to the banking system 600.

As used herein, a “communication interface” generally includes a modem, server, transceiver, and/or other device for communicating with other devices on a network, and/or a user interface for communicating with one or more users. Referring again to FIG. 6, the network communication interface 610 is a communication interface having one or more communication devices configured to communicate with one or more other devices on the network 350, such as the mobile device 400, the banking system 600, the other financial institution banking systems 370, and the alias determination server 500. The processing device 620 is configured to use the network communication interface 610 to transmit and/or receive data and/or commands to and/or from the other devices connected to the network 350.

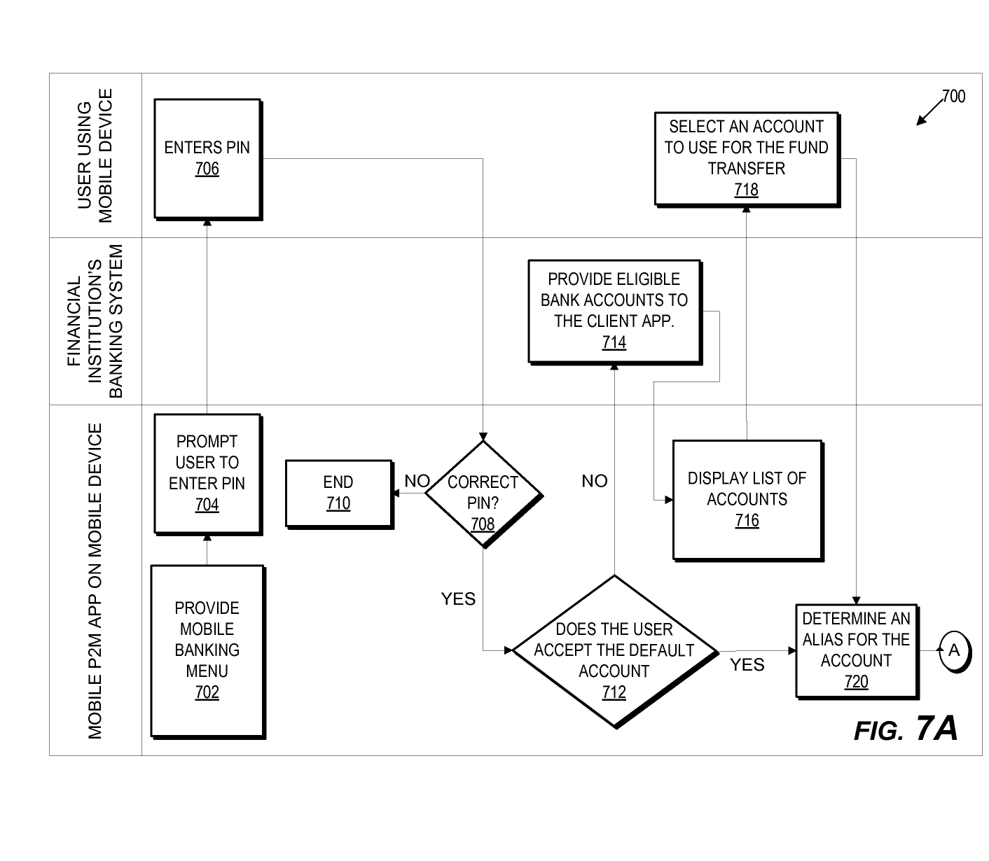

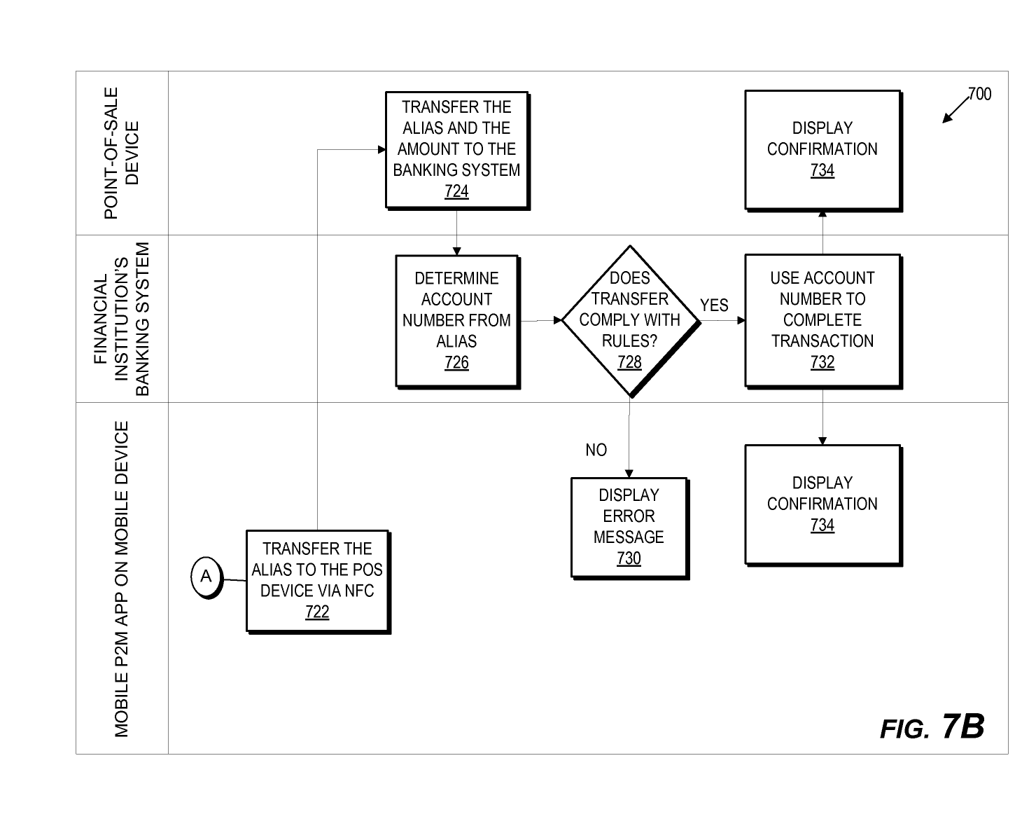

FIGS. 7A-7B provide flow charts illustrating a process 700 for using a near field communication device to conduct a transaction with an alias, in accordance with embodiments of the invention. FIGS. 7A-7B illustrate the flow chart in terms of “swim lanes” associated with entities which may perform the operations in each respective swim lane. The entities illustrated in the exemplary Figures are a financial institution's banking system, a user using a mobile device, a mobile P2M application on a mobile device, and a point-of-sale device at a business. However, it should be noted that other entities, such as an alias determination server, could also be involved and some embodiments of the invention may not be limited to the entities illustrated in FIGS. 7A-7B. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

In block 702 of FIG. 7A, in some embodiments the P2M application provides a banking application on the user's mobile device. In some embodiments, the P2M application may be set up by the user in advance of conducting a transaction. The P2M application may be downloaded, installed, and customized by the user for the user's mobile device. In some embodiments, the user establishes initial settings in the P2M application when installing the application. For example, the user may enter one or more financial accounts that may be used with the payment system. Each account may be given a nickname or unique identifier. For example, the user may register three accounts, such as a checking, a credit card, and a savings account, with the P2M payment system. Each account receives a nickname such as “Account A,” “Account B,” and “Account C.”

In an embodiment, the user establishes a default payment method for the P2M payment system and/or rules associated with transactions conducted through the P2M payment system. In some embodiments, the mobile P2M application displays a menu page on which the user can navigate to an accounts function, a bill-paying function, a transfer funds function, or a location function. Further, in some embodiments the P2M application indicates to the user that the user is in a secure area of the banking system. In still further embodiments, the bank menu page has a text area where error messages are displayed and allows users to sign out from their accounts on any mobile webpage by providing an appropriate hyperlink or button.

In some embodiments depicted in block 704, the P2M application includes an authentication process whereby the user authenticates the user's identity and grants access to the P2M application. For example, the user may enter a personal identification number (PIN), password, or use biometric security features to gain access to the application. As shown in block 706, in some embodiments the user enters the PIN into the mobile device to gain access to the P2M application. In an embodiment, activating the P2M application automatically activates the NFC chip. In decision block 708, the P2M application determines whether the PIN is correct. If the user enters the incorrect PIN, the process ends, as shown in block 710. In some embodiments, the user is given multiple opportunities to enter the PIN. In further embodiments, the authentication procedure varies if the user enters an incorrect PIN the first time. For example, the user may be prompted to enter more detailed information such as the user's mailing address or zip code. In another embodiment, the P2M application includes a procedure to assist the user if the user forgets the PIN. For example, the user may be able to select an option whereby a new PIN is generated and sent to the user via email or text message. In some embodiments, the P2M application also presents disclosure text regarding any possible fees that will be incurred by the user for making a transfer.

If the user enters the correct PIN, the user is given the option to change the method of payment from the default payment method to another payment method, as indicated by decision block 712. In an embodiment, changing of the default payment method occurs by selecting an option on the mobile device. In an embodiment, different payment devices or methods, such as credit cards, debit cards, checking accounts, savings accounts, investment accounts, reward accounts, gift card accounts, money market accounts, etc., may be selected as either the default account or as an alternative account. The accounts available to the P2M system may be displayed by nicknames. In an embodiment, each account has both a nickname, such as “User's Credit Card,” and the payment identification number, such as a three digit number, that is associated with the account.

In block 714, in some embodiments the banking system provides eligible financial institution accounts to the P2M application. In an embodiment, the banking system also provides balances to the P2M application. As discussed, the accounts may be displayed on a screen of the mobile device such that the user can select an account to use when conducting the instant transaction. In further embodiments, however, only a single account is available to the user for P2M transactions. In this embodiment, the single account may be an account specifically designed for P2M transactions or it may be an account designated by the user from among the user's standard accounts (e.g., checking, credit card, etc.). If only a single account is available to the user for P2M transactions, then the step in block 706 may be skipped. In this scenario, the single available account is the default account. Further, if the user sets up rules relating to accounts to use for specific types of transactions, then the user may not need to select an account. For example, the user may set up a rule that a P2M transfer of less than $20 should be conducted through a checking account and that any P2M transfer of greater than or equal to $20 should be conducted through a credit card account. In some embodiments, these accounts are stored on the user's mobile device and the banking system does not communicate with the P2M application.

In block 716, in some embodiments the P2M application 694 displays a list of eligible financial institution accounts that can participate in the P2M transfer. In further embodiments, the P2M application also indicates the balances of the accounts or that the account balances may reflect transactions that have not yet been posted to the user's account. For example, the P2M application 694 may display the accounts loaded into the application by the user when setting up the P2M application.

In block 718, in some embodiments the user 310 selects an account to use for the fund transfer. As discussed previously, if only a single account is available or if rules pre-determine the account that will be used for the transfer then this step may not be completed. In some embodiments, the user selects the account by pressing a button on the mobile device or selecting an option on a touch-sensitive screen.

In some embodiments depicted in block 720, the P2M application 694 determines an alias for the user's account. In an embodiment, the alias provided by the P2M application includes the issuer identification number, the bank identification number, the user identification number, the payment identification number, and a checksum. The issuer identification number and bank identification number assist the server in routing the transaction to the proper financial institution. The user identification number allows the server to identify the user associated with the alias and the payment identification number allows the server to identify which of a plurality of payment methods the user is using for the transaction. The checksum is a means to detect accidental errors in the alias, such as via the Luhn algorithm.

The issuer identification number and the bank identification number assist the computer-implemented method in routing the transaction authorization request to the proper location. As discussed previously, in an embodiment the issuer identification number is a two digit number that represents the payment channel, e.g., Visa™ or Mastercard™, being using for the transaction. Standard issuer identification numbers are known that represent different payment channels. In some embodiments, the bank identification number is an additional four numbers that represents the bank issuing the payment channel. For example, a Visa card issued by Bank A.

The user identification number and payment identification number are used by the computer-implemented method to identify a specific account at the financial institution represented by the issuer identification number and bank identification number. In some embodiments, the user identification number matches up with a user in a database associated with the financial institution. Once the user is known, the payment identification number is used to identify the payment method of the user that will be used. In an embodiment, the payment identification number is a three digit number between 000 and 999. Each payment method of the user is assigned a different payment identification number. While the user identification number and payment identification number can be any series of numbers, in an embodiment the user identification number is six digits long and the payment identification number is three digits long. In this embodiment, the alias comprising the issuer identification number, bank identification number, user identification number, payment identification number, and checksum is sixteen digits long, the same length as a standard account number.

An example of a static alias is represented by the number 410001XXXXXX002Y. In this example, “41” is the issuer identification number and indicates that the transaction is conducted via Visa, “0001” is the bank identification number and indicates that the Visa was issued by Bank A, “XXXXXX” is the user identification number and identifies the user in coordination with a financial institution database, “002” is the payment identification number and indicates that the user's second payment method is selected, and “Y” is the checksum (e.g., the Luhn algorithm, etc.). In an embodiment, the static alias is determined by the financial institution so that there is no conflict between the static alias and an existing account number. In another embodiment, the static alias includes an additional identifier, such as an additional digit or a diagnostic identifier at an existing digit (e.g., a letter or a number that identifies the account number as a static alias) so that the financial institution is able to distinguish between static aliases and actual account numbers.

In another embodiment, the computer-implemented method generates a dynamic alias for use with the transaction. In some embodiments, the dynamic alias is generated in a similar manner to the static alias but with the additional step of modifying using an algorithm at least a portion of the alias, such as the user identification number. In another embodiment, the entire alias is modified using the algorithm, or the user identification number and payment identification number are modified. In an embodiment, the algorithm modifies the alias based on a characteristic of the transaction. For example, the time of the transaction may be used to modify the user identification number and generate a dynamic alias. In another example, the transaction location and/or transaction amount are used to generate the dynamic alias. The location may be determined by the mobile device's geopositioning device, such as the GPS. For example, the mobile device may determine the user's coordinates and modify the user identification number using the user's coordinates. In a still further embodiment, the computer-implemented method receives the amount of the transaction, either from input by the user or from the point-of-sale device via the NFC connection, and modifies the user identification number based on the amount of the transaction. It should be understood that any manner of algorithm may be used to modify the user identification number with the characteristics of the transaction.

Turning now to block 722 of FIG. 7B, the mobile P2M application 694 transfers the alias to the point-of-sale device via NFC. In an embodiment, the user brings the mobile device into close proximity to the NFC receiver on the point-of-sale device, such as lightly tapping the mobile device to the NFC receiver. In some embodiments, the mobile device automatically syncs with the NFC receiver on the point-of-sale device without requiring advance pairing of the devices. The mobile device wirelessly transfers the alias to the point-of-sale device so that the point-of-sale device can process the transaction.

In block 724, the point-of-sale device, having received the user's alias, communicates the alias and the transaction amount to the banking system 600. In some embodiments, the point-of-sale device also transfers the time of the transaction or the location of the transaction. In still further embodiments, additional information is communicated to the banking system 600, such as taxes or fees associated with the transaction, demographic data associated with the transaction, customer history data, or other data that may be used to customize and/or personalize the system and method and increase customer satisfaction. In an embodiment, the point-of-sale device communicates the alias and the amount over the network 350. In some embodiments, the alias and amount are encrypted.

In block 726, the alias is identified and the account number is determined. In an embodiment, the alias determination server identifies data received from a point-of-sale device as comprising an alias instead of an actual account number. For example, the data transferred from the point-of-sale device may include a diagnostic character that indicates an alias was used. If the diagnostic character indicates that a static alias was used, the alias determination server may user the static alias to look up the account number in a database. For example, the alias determination server may use the issuer identification number, the bank identification number, the user identification number, and the payment identification number to identify the account. In an embodiment, the user identification number is used to match up the payment with a customer of the bank and then the payment identification number is used to determine which account for the customer will be involved in the transaction. In an embodiment, the alias datastore is a database that includes static aliases and associated information such as account numbers, contact information, location, and other information. In some embodiments, the alias is then associated with a financial institution account.

In an embodiment, the alias determination server identifies the alias as comprising a dynamic alias and determines the account number accordingly. For example, the alias determination server may determine the algorithm that modified the user identification number and reconstruct the user identification number based on the algorithm. In an embodiment, the characteristic of the transaction that is used to modify the user identification number is transferred to the financial institution. In one embodiment, the mobile device transfers the characteristic the point-of-sale device, which then transfers the characteristic to the financial institution. In another embodiment, the mobile device transfers the characteristic directly to the financial institution. For example, the P2M application may wirelessly transfer data to the financial institution indicating that the user is conducting a transaction at a specific time. In a further embodiment, the financial institution determines the characteristic of the transaction. For example, the financial institution may determine the location of the point-of-sale device, such as the ATM, and use that location to reconstruct the user identification number. When the alias determination server has the dynamic alias and the characteristic of the transaction that was used to modify the user identification number, the alias determination server is able to reverse the process that generated the dynamic alias and reconstruct the user identification number. Then, the alias determination server matches the user identification number and payment identification number up with a financial account.

In some embodiments, the banking system 600 determines whether the transfer complies with pre-determined rules, as shown in decision block 728. In an embodiment, the pre-determined rules are established by the user. In another embodiment, the pre-determined rules are established by the business or the financial institution. Any combination of user, business, and financial institution may establish rules governing P2M transfers. For example, a P2M transfer may be limited to amounts less than a pre-determined amount, such as $1000. If a user attempts to transfer more than $1000 using the P2M system, the user will receive an error message on the mobile device, as depicted in block 730. These rules are affected by several factors including, but not limited to, the user's identity, the business's identity, the length and nature of the user's relationship with the financial institution, the length and nature of the business's relationship with the financial institution, the amount of funds that the user has deposited at the financial institution, the user's financial institution status, etc. Other types of rules that can be established for P2M transfers include rules regulating the frequency of P2M transfers, rules regulating the types of recipients (e.g., specific businesses may not receive P2M transfers or specific categories may not receive P2M transfers, etc.), rules regulating the timing of P2M transfers (e.g., no transfers on weekends or no transfers after 11 pm, etc.), rules regulating the location of P2M transfers (e.g., determining the location of the point-of-sale device and preventing transactions based on the location, etc.). It should be understood that other types of rules or combinations of rules are possible. If the transaction does not comply with the pre-determined rules, an error message is displayed as depicted in block 730.

If the banking system determines that the transfer complies with the pre-determined rules, then in some embodiments the banking system prompts the user to confirm the transaction. In one embodiment, the banking system and computer-implemented method prompts the user to confirm the transaction at the point-of-sale device. For example, the point-of-sale device may display a query asking whether the user approves the transaction. The query may include the user's account type (e.g., checking or credit card) and the amount. In another embodiment, the banking system and computer-implemented method prompts the user to confirm the transaction via the mobile device. For example, the user may receive an automatically generated text message or email from the banking system that asks the user to respond to the message to confirm the transaction. In some embodiments, the user confirms the transaction because the transaction amount has changed due to taxes or fees associated with the purchase of a product or service. In a still further embodiment, the user and/or financial institution establishes rules whereby the user does not need to confirm the transaction if certain conditions apply. For example, the user may not need to confirm the transaction if the transaction amount is below a certain amount, if the transaction is being conducted at specific merchants or in a specific location, or if the transaction is being conducted at a specific time. As should be understood, the user may also cancel the transaction by not confirming the transaction request. The user may cancel the transaction for any reason. It should be understood that other means for prompting the user to confirm the device are possible.

In further embodiments, the banking system provides offers to the user before conducting the transaction. In some embodiments, a coupon, discount, or deal, such as a time-limited deal, is provided to the user prior to completing the transaction. For example, the characteristic of the transaction that is provided to the financial institution may be used to target offers to the user. If the user's location is known, offers may be targeted based on geographic region or based on the category of the business wherein the user is shopping. If the time of the transaction is known, offers may be targeted based on the local time, such as offers for restaurants around mealtimes. If multiple characteristics of the transaction are transferred to the financial institution, offers may be targeted based on more than one characteristic. For example, if it is known that the user is traveling based on the user's location and it is evening, the user may be provided offers to local hotels. These offers may be further targeted based on the user's transaction history available to the financial institution. For example, if the financial institution knows that the user recently purchased a hotel stay the offer may be targeted to gas stations rather than hotels. In some embodiments, the offer is targeted to the merchant where the user is currently shopping, such as a rewards offer or discount for customer loyalty. In other embodiments, the offer is targeted to other businesses. In an embodiment, the user receives the offer from the merchant, such as when the merchant is informed that the transaction completed. In other embodiments, the user receives the offer directly from the financial institution, such as via the user's mobile device.

When the alias is associated with the financial institution account number, the banking system uses the financial institution account number to complete an ACH transfer or other type of transfer, as depicted in block 732. In some embodiments, the transfer is completed using standard channels.

Subsequently, the process moves to block 734 where the banking system provides confirmation to the user and/or business that a transfer or a notice of transfer request to the business has been initiated and displays the information regarding the transfer. In some embodiments, the mobile device provides a confirmation page that displays the name or nickname of the transfer-from account, the amount transferred, the fee incurred by the user for making the transfer, the total cost of the transfer, and the date on which the transfer was executed. In an exemplary embodiment, the confirmation provided to the user and/or business does not include the user's actual account number, thus maintaining security of the account number within the financial institution's banking system.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, optical fiber cable, radio frequency signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

We claim:

1. A computer-implemented method for conducting a financial transaction via a near field communication device, the method comprising:
receiving an alias for a user from a merchant, wherein the merchant receives the alias via a near field communication device;
determining, via a computing device processor, an account associated with the alias; and
conducting the financial transaction using the account.

2. The computer-implemented method according to claim 1, wherein the alias is a static alias for the user.

3. The computer-implemented method according to claim 1, wherein the alias comprises an issuer identification number, a bank identification number, a user identification number, and a payment identification number.

4. The computer-implemented method according to claim 3, wherein the user identification number is associated with the user in a database available to the financial institution.

5. The computer-implemented method according to claim 1, wherein the alias is dynamically-generated for the transaction.

6. The computer-implemented method according to claim 5, wherein the dynamically-generated alias is generated using an algorithm that modifies the alias based on a characteristic of the financial transaction.

7. The computer-implemented method according to claim 6, wherein the characteristic is selected from the group consisting of the time of the transaction, the amount of the transaction, and the location of the transaction.

8. The computer-implemented method according to claim 1, further comprising:
determining a characteristic of the transaction; and
generating a dynamic alias for the user based on the characteristic of the transaction.

9. The computer-implemented method according to claim 8, wherein the financial institution determines the characteristic of the transaction independently of the user.

10. The computer-implemented method according to claim 1, wherein the characteristic of the transaction is transmitted from a mobile device of the user to the financial institution.

11. A computer program product for conducting a financial transaction via a near field communication device, the computer program product comprising a computer-readable medium having computer-executable instructions for performing:
receiving an alias for a user from a merchant, wherein the merchant receives the alias via a near field communication device;
determining, via a computing device processor, an account associated with the alias; and
conducting the financial transaction using the account.

12. The computer program product of claim 11, wherein the computer-readable medium has computer-executable instructions for modifying the alias based on a characteristic of the transaction.

13. The computer program product of claim 12, wherein modifying the alias comprises using an algorithm to alter at least one element of the alias, wherein the elements of the alias comprise an issuer identification number, a bank identification number, a user identification number, and a payment identification number.

14. The computer program product of claim 12, wherein determining the account associated with the alias comprises using the algorithm to reverse the modifications to the alias.

15. The computer program product of claim 12, wherein the alias is modified based on a characteristic of the transaction, wherein the characteristic comprises at least one of a location of the transaction, a time of the transaction, and an amount of the transaction.

16. The computer program product of claim 12, wherein the characteristic of the transaction is transferred from the user to a financial institution independent of the merchant.

17. The computer program product of claim 11, further comprising computer-executable instructions for informing the merchant that the transaction was conducted.

18. The computer program product of claim 11, wherein the determining, via a computing device processor, an account associated with the alias comprises:
determining routing for the financial transaction from an issuer identification number and a bank identification number;
determining a user from a user identification number; and
determining an account from a payment identification number.

19. A system for conducting a financial transaction via a near field communication device, the system comprising:
a computer apparatus including a processor and a memory; and
a payment system module stored in the memory, executable by the processor and configured to:
receive an alias for a user from a merchant, wherein the merchant receives the alias via a near field communication device;
determine, via a computing device processor, an account associated with the alias; and
conduct the financial transaction using the account.

20. The system for conducting a financial transaction via a near field communication device of claim 19, the system further comprising:
a near field communication receiver at the merchant for receiving the alias from the user; and
a communication device at the merchant for transmitting the alias from the merchant to the financial institution.

21. The system for conducting a financial transaction via a near field communication device of claim 19, the system further comprising a database associating the user with a user identification number.

22. The system for conducting a financial transaction via a near field communication device of claim 21, wherein the database further associated at least one payment method with a payment identification number.

23. The system for conducting a financial transaction via a near field communication device of claim 19, wherein the payment system module is further configured to use an algorithm to determine a user identification number from a dynamic alias.

24. The system for conducting a financial transaction via a near field communication device of claim 19, wherein the payment system module is further configured to receive a characteristic of the transaction.

25. The system for conducting a financial transaction via a near field communication device of claim 24, wherein the characteristic of the transaction is received from the user.

26. The system for conducting a financial transaction via a near field communication device of claim 19, wherein the characteristic of the transaction is received from the merchant.

27. The system for conducting a financial transaction via a near field communication device of claim 19, wherein the payment system module is further configured to:
route the financial transaction based on an issuer identification number and bank identification number in the alias;
identify the user from the user identification number; and
identify a payment method for the user from a payment identification number.

28. The system for conducting a financial transaction via a near field communication device of claim 19, wherein the near field communication device encrypts the alias before communicating the alias to the merchant.

29. The system for conducting a financial transaction via a near field communication device of claim 19, wherein the payment system module is further configured to provide an offer to the user.

30. The system for conducting a financial transaction via a near field communication device of claim 29, wherein the offer is customized for the user based on the user's transaction history.
